(19) United States
(12) Patent Application Publication
(10) Pub. No.: US 2007/0283897 A1
(43) Pub. Date: Dec. 13, 2007

(54) Bottle holder for laboratory guinea pig cages

(76) Inventor: Lazar Y. Vereta, Rockville, MD (US)

Correspondence Address: Ilya Zborovsky, 6 Schoolhouse Way, Dix Hills, NY, 11746, US

(21) Appl. No.: 11/375,388

(22) Filed: Mar. 15, 2006

(51) Int. Cl. A01K 7/00

(52) U.S. Cl. 119/477

(57) ABSTRACT

A bottle holder for a laboratory guinea pig cage with two longitudinal walls and two transverse walls, has two elongated walls, a bottom connecting the elongated walls with one another, and a bent over element configured to be fitted on an upper edge of one of the walls of the cage.

### BACKGROUND OF THE INVENTION

The present invention relates to bottle holders for laboratory guinea pig cages.

Bottle holders for laboratory cages are known in many modifications. Usually they are fixed on a laboratory cage in its upper area, in many instances above the cage itself, and occupy a significant space, so that a guinea pig has difficulties in drinking water. It is believed that the existing bottle holders for guinea pig laboratory cages can be further improved.

### SUMMARY OF THE INVENTION

Accordingly, it is an object of the present invention to provide a bottle holder for laboratory guinea pig cages, which is a further improvement of the existing bottle holders.

In keeping with these objects and with others which will become apparent hereinafter, one feature of the present invention resides, briefly stated, in a bottle holder for a laboratory guinea pig cage which has two longitudinal walls and two transverse walls, wherein the bottle holder has two elongated walls; a bottom connecting said elongated walls with one another; and a bent over element configured to be fitted on an upper edge of one of said walls of the cage.

In accordance with another feature of the present invention, said bent over element is provided on one of said elongated walls and is fittable over the upper edge of one of said longitudinal walls of the cage.

In accordance with still a further feature of the present invention, the bent-over element extending transversely to said elongated walls and is fittable over an upper edge of one of the transverse walls of the cage.

In accordance with an additional feature of the present invention, said elongated walls have an end facing toward the interior of the cage in installed position of the bottle holder, a connecting element connects said elongated walls at said end and is provided with an opening for a sipper tube of a bottle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a bottle holder for laboratory guinea pig cages in accordance with the present invention;

FIG. 2 is a front view of the bottle holder for laboratory guinea pig cages of FIG. 1;

FIGS. 3, 4 and 5 are a side view, an end view, and a top view of a laboratory guinea pig cage with the bottle holder in accordance with the present invention in installed condition; and

FIG. 6 is a view showing a further modification of the bottle holder for laboratory guinea pig cages in accordance with the present invention.

### DESCRIPTION OF THE PREFERRED EMBODIMENTS

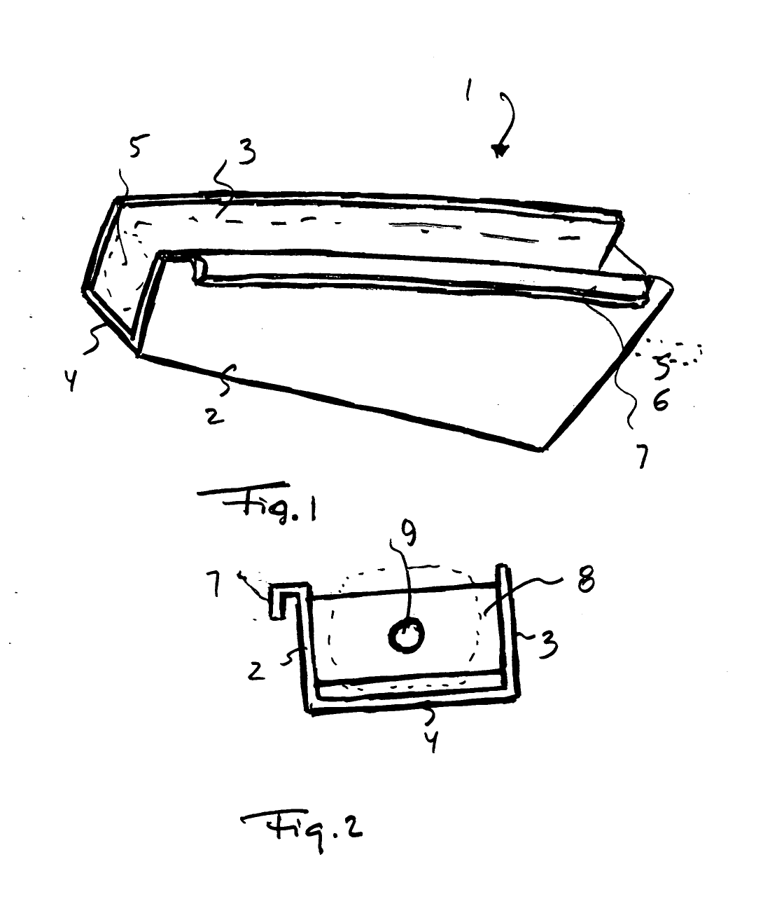

A bottle holder for laboratory guinea pig cages is identified as a whole with reference numeral 1 in FIG. 1. It has two elongated walls 2 and 3 which are connected with one another at their lower ends by a bottom 4 so as to form a cradle in which a bottle 5 with a sipper tube 6 can be inserted.

As shown in FIGS. 1 and 2, a bent over element 7 is provided in the inventive bottle holder. The bent over element 7 extends from an upper edge of the elongated wall 2 first in a substantially horizontal direction, and then downwardly, substantially in the same direction as the elongated wall 2 so as to form a hook-shaped structure.

The bottle holder can be further provided with a transverse element 8 which connects the ends of the elongated walls 2 and 3 facing toward the interior of the cage in the installed condition and has an opening 9.

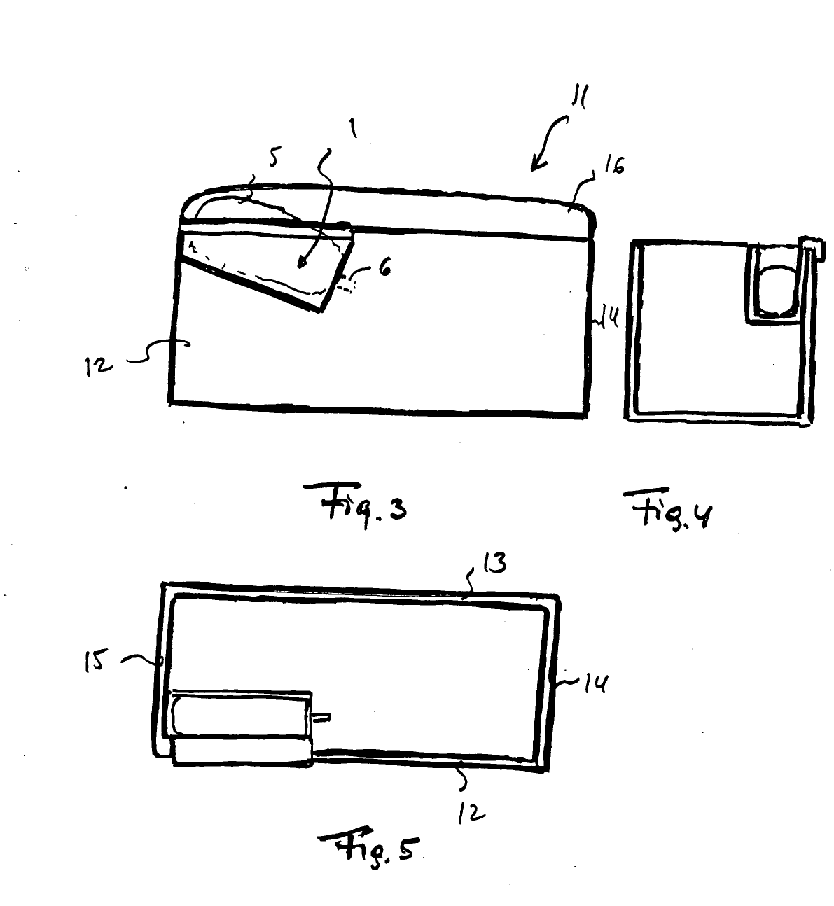

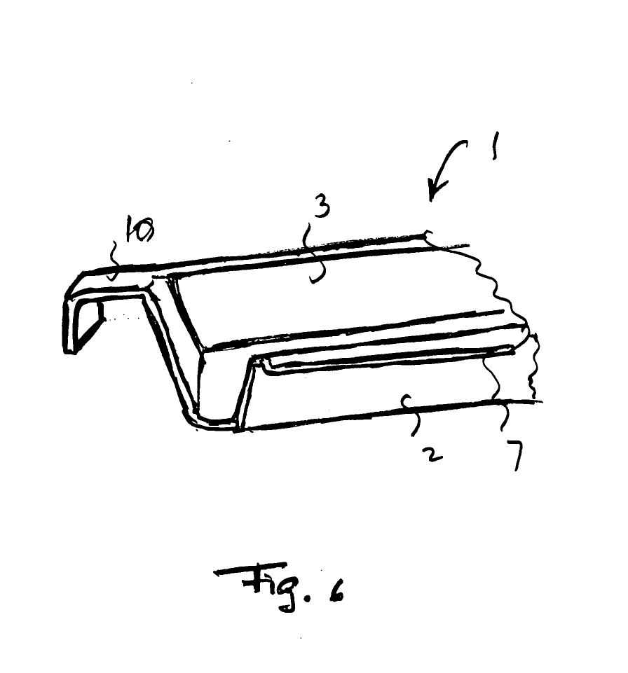

FIGS. 3-5 show a laboratory guinea pig cage which is identified as a whole with reference numeral 11. The cage 11 has two longitudinal walls 12 and 13 and two transverse walls 14 and 15. It can be provided with a top 16, which is removed in FIGS. 4 and 5.

The bottle holder 1 is placed into the cage 11 so that its bent over element 7 is fitted over the upper edge of the longitudinal wall 12 and is thereby held on it. The bottle 5 is located inside the bottle holder 1 and its sipper tube 6 extends through the opening 9 in the transverse element 8 connecting the elongated walls with one another.

As can be seen from consideration of FIGS. 3 and 5, a significant space is provided in the cage between the bottle holder 1 and the wall 14 so that a guinea pig can be comfortable in drinking position. The more comfortable drinking position provides less water waste and keeps the bedding drier.

Naturally, a filter can be installed in the cage as well in a more favorable manner. The bottle holder is formed as a single-piece element including its components 2, 3, 4, and 7, and in some cases with its component 8 as well. It can be composed of a metal sheet, a wire, or a plastic.

In accordance with another embodiment of the present invention shown in FIG. 6, an additional bent over element 10 can be provided at an opposite rear end of the bottle holder and configured substantially hook-shaped. It can extend from a rear transverse wall of the bottle holder. In the installed condition, it is fitted over an upper edge of the rear transverse wall 15 of the cage 11, so as to provide additionally a reliable mounting of the bottle holder 1 in the guinea pig cage 11. As can be seen from the drawings, the elongated walls 2 and 3 are substantially triangular.

It will be understood that each of the elements described above, or two or more together, may also find a useful application in other types of constructions differing from the types described above.

While the invention has been illustrated and described as embodied in a bottle holder for laboratory guinea pig cages, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A bottle holder for a laboratory guinea pig cage having two longitudinal walls and two transverse walls, the bottle holder comprises two elongated walls; a bottom connecting said elongated walls with one another; and a bent over element configured to be fitted on an upper edge of one of said walls of the cage.

2. A bottle holder as defined in claim 1, wherein said bent over element is provided on one of said elongated walls and is fittable over the upper edge of one of said longitudinal walls of the cage.

3. A bottle holder as defined in claim 1; and further comprising an additional bent-over element extending transversely to said elongated walls and fittable over an upper edge of one of the transverse walls of the cage.

4. A bottle holder as defined in claim 1, wherein said elongated walls have an end facing toward an interior of the cage in installed position of the bottle holder; and further comprising a connecting element which connects said elongated walls at said end; said connecting element being provided at opening for a sipper tube of a bottle.

5. A bottle holder as defined in claim 1, wherein said bent over element is formed of one piece with one of said elongated walls.

6. A bottle holder as defined in claim 3, wherein said additional bent over element is formed of one piece with a remaining part of the bottle holder.

7. A bottle holder as defined in claim 1, wherein the bottle holder is formed as a one-piece element.
